(19) United States
(12) Patent Application Publication
(10) Pub. No.: US 2026/0313235 A1
(43) Pub. Date: Oct. 8, 2026

(54) IMAGING UNIT AND IMAGE PICKUP APPARATUS

(71) Applicant: CANON KABUSHIKI KAISHA, Tokyo (JP)

(72) Inventors: SHIMPEI ISHIKAWA, Kanagawa (JP); KAZUYA KARIBE, Kanagawa (JP)

(21) Appl. No.: 19/566,055

(22) Filed: Mar. 13, 2026

(30) Foreign Application Priority Data
Apr. 4, 2025 (JP) 2025-062688

(51) Int. Cl. H04N 23/68; G03B 17/55; H04N 23/52; H04N 23/54

(52) U.S. Cl. CPC H04N 23/687; G03B 17/55; H04N 23/52; H04N 23/54; H04N 23/6812

(57) ABSTRACT

An imaging unit includes an image sensor, a fixed portion, a movable portion that holds the image sensor and is supported movably relative to the fixed portion in a plane perpendicular to an optical axis, and a magnet and a coil configured to drive the movable portion. The fixed portion includes a first holding member that holds the magnet or the coil, and a first heat dissipating member. The movable portion includes a second holding member that holds the image sensor, and a second heat dissipating member. The first heat dissipating member has a first surface perpendicular to the optical axis. The second heat dissipating member has a second surface perpendicular to the optical axis. The first surface and the second surface have an opposing region in which the first surface and the second surface face each other in an optical axis direction.

### BACKGROUND

### Field of the Technology

The present disclosure relates to an imaging unit and an image pickup apparatus.

### Description of the Related Art

Japanese Patent Application Laid-Open No. 2006-174226 discloses an imaging unit that includes a movable portion having a cooling element and a first heat dissipating member, and a fixed portion having a second heat dissipating member for dissipating heat from the movable portion, the imaging unit being configured to dissipate heat of an image sensor to the fixed portion without physical contact.

In the configuration disclosed in Japanese Patent Application Laid-Open No. 2006-174226, since the cooling element is disposed in the movable portion, the weight of the movable portion increases, resulting in a reduction in the driving performance of an image stabilizing mechanism.

### SUMMARY

An imaging unit according to one aspect of the present disclosure may include an image sensor, a fixed portion, a movable portion that holds the image sensor and is supported movably relative to the fixed portion in a plane perpendicular to an optical axis, and a magnet and a coil configured to drive the movable portion. The fixed portion may include a first holding member that holds the magnet or the coil, and a first heat dissipating member. The movable portion may include a second holding member that holds the image sensor, and a second heat dissipating member. The first heat dissipating member may have a first surface perpendicular to the optical axis. The second heat dissipating member may have a second surface perpendicular to the optical axis. The first surface and the second surface may have an opposing region in which the first surface and the second surface face each other in an optical axis direction. An image pickup apparatus having the above imaging unit also constitutes another aspect of the present disclosure.

Features of the present disclosure will become apparent from the following description of embodiments with reference to the attached drawings. The following description of embodiments will be described by way of example.

### BRIEF DESCRIPTION OF THE DRAWINGS

FIG. 1 is a schematic configuration diagram of an imaging system according to the present embodiment.

FIG. 2A is an exploded perspective view of a first image stabilizing unit according to the present embodiment.

FIG. 2B is an exploded perspective view of the first image stabilizing unit according to the present embodiment when viewed from a direction different from that of FIG. 2A.

FIG. 3A is an exploded perspective view of a fixed portion according to the present embodiment.

FIG. 3B is an exploded perspective view of the fixed portion according to the present embodiment when viewed from a direction different from that of FIG. 3A.

FIG. 4A is an exploded perspective view of a movable portion according to the present embodiment.

FIG. 4B is an exploded perspective view of the movable portion according to the present embodiment when viewed from a direction different from that of FIG. 4A.

FIG. 5A is a rear view of the first image stabilizing unit according to the present embodiment.

FIG. 5B is a sectional view of the first image stabilizing unit according to the present embodiment.

FIG. 5C is a projected view illustrating a relationship between a fixed-portion heat dissipating plate and a movable-portion heat dissipating plate according to the present embodiment.

FIG. 6 is a diagram illustrating a relationship between a distance L and the temperature of an image sensor according to the present embodiment.

### DESCRIPTION OF THE EMBODIMENTS

Referring now to the accompanying drawings, a detailed description will be given of embodiments according to the present disclosure. Corresponding elements in respective figures will be designated by the same reference numerals, and a duplicate description thereof will be omitted.

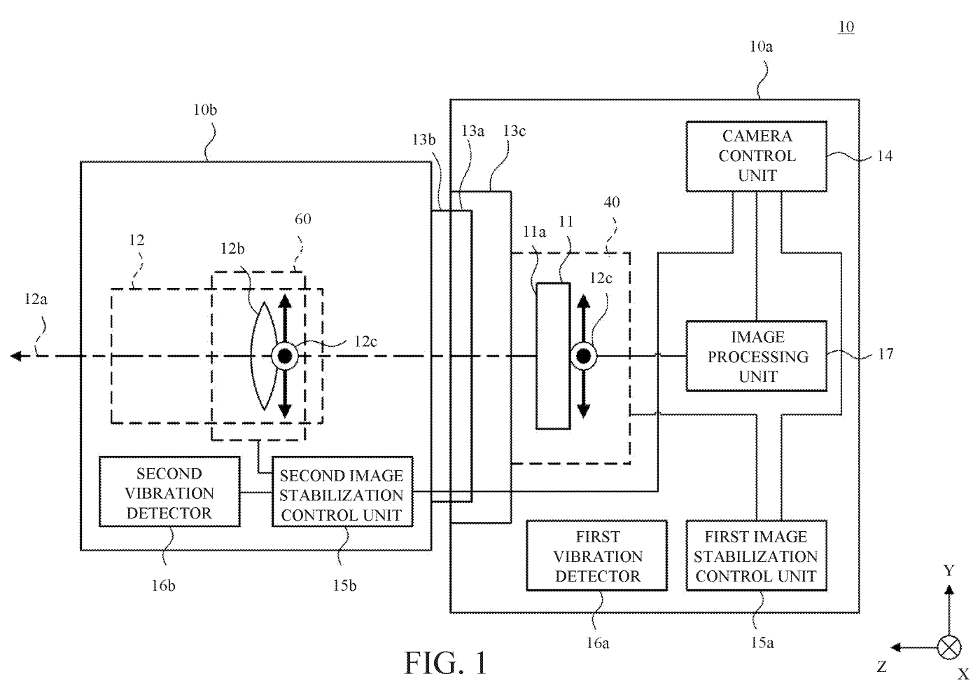

First, an imaging system 10 according to the present embodiment will be described with reference to FIG. 1. FIG. 1 is a schematic configuration diagram of the imaging system 10 according to the present embodiment. Some of the functional blocks illustrated in FIG. 1 are implemented by causing a computer program stored in a memory serving as a storage medium (not illustrated) to be executed by a CPU or the like serving as a computer included in the imaging system 10 (not illustrated). However, the present embodiment is not limited to this example, and part or all of these functions may be implemented by hardware. Examples of such hardware include dedicated circuits (ASICs) and processors (reconfigurable processors, DSPs). The respective functional blocks illustrated in FIG. 1 may not be incorporated in the same housing, and may be configured by separate devices connected to each other via signal paths.

The imaging system 10 is used, for example, for a so-called mirrorless digital camera, and includes a body unit (image pickup apparatus, camera body) 10a and a lens apparatus (interchangeable lens) 10b attached to and detachable from the body unit 10a. However, the present embodiment is not limited to this example, and may also be applied to an image pickup apparatus in which the camera body and the lens apparatus are integrated.

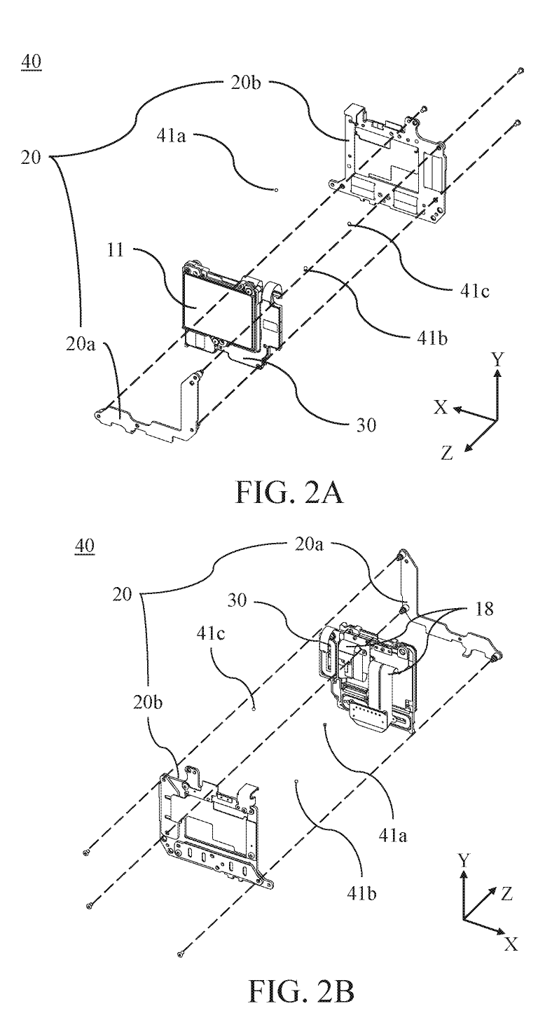

The body unit 10a includes an image sensor 11 having an imaging surface 11a, an imaging flexible printed circuit (FPC) 18 (see FIG. 2B), a base member 13c, and a body-unit-side mount member 13a. The body unit 10a further includes a camera control unit 14, a first image stabilization control unit 15a, a first vibration detector 16a, an image processing unit 17, and a first image stabilizing unit (imaging unit) 40.

The lens apparatus 10b includes an imaging optical system 12 including an image stabilizing lens 12b, a lens-side mount member 13b, a second image stabilization control unit 15b, a second vibration detector 16b, and a second image stabilizing unit 60.

In the present embodiment, a virtual ray representing a light beam irradiated onto the imaging surface 11a of the image sensor 11 through the imaging optical system 12 (a direction perpendicular to the imaging surface 11a) is referred to as an optical axis 12a, and a plane orthogonal to the optical axis 12a (a plane perpendicular to the optical axis 12a) is referred to as an optical-axis-orthogonal plane 12c. The optical axis 12a passes through the center of the imaging surface 11a and is orthogonal to the imaging surface 11a. In order to clarify the arrangement and positional relationship of components constituting the imaging system 10 within the imaging system 10, as illustrated in FIG. 1, mutually orthogonal X, Y, and Z directions are defined. The Z direction is a direction parallel to the optical axis 12a, the X direction is a width direction (horizontal direction) of the imaging system 10, and the Y direction is a height direction (vertical direction) of the imaging system 10. The optical-axis-orthogonal plane 12c corresponds to an XY plane.

The image sensor 11 includes a photoelectric conversion element such as a CMOS image sensor or a CCD image sensor, and is disposed such that the imaging surface 11a faces the object side (lens apparatus 10b side) and is orthogonal to the optical axis 12a. The image sensor 11 generates an image signal by photoelectrically converting an optical image of an object formed on the imaging surface 11a by the imaging optical system 12. The image signal generated by the image sensor 11 is transmitted to the image processing unit 17 via the imaging FPC 18 (not illustrated), subjected to various processing to be converted into image data, and stored in a memory (storage device) (not illustrated).

The camera control unit 14 is a processing unit in a main IC (not illustrated), receives user input operations via an operation unit (not illustrated), and controls overall operations of the imaging system 10. The camera control unit 14 includes a CPU serving as a computer, and controls each component of the imaging system 10 by executing a computer program stored in a memory (not illustrated).

The imaging optical system 12 is configured by a lens unit (not illustrated) disposed inside the lens apparatus 10b, and forms an image of light from an object (not illustrated) on the imaging surface 11a of the image sensor 11. In the imaging system 10, in order to position the image sensor 11 with high positional accuracy relative to the optical axis 12a, the image sensor 11 is mounted on the base member 13c provided in the body unit 10a, and the lens apparatus 10b is also connected to the base member 13c.

The image sensor 11 is mounted on the base member 13c via the first image stabilizing unit 40. The lens apparatus 10b is connected to the base member 13c via the lens-side mount member 13b and the body-side mount member 13a.

The first image stabilizing unit 40 corrects an image blur caused by vibration occurring in the imaging system 10 by moving the image sensor 11 in the X and Y directions or rotating the image sensor 11 within the XY plane, thereby allowing a clear object image to be obtained. More specifically, when the orientation of the imaging system 10 changes relative to an object during imaging, the imaging position of the object light beam on the imaging surface 11a of the image sensor 11 changes, thereby causing blur in the image obtained through the image sensor 11.

In a case where the orientation change of the imaging system 10 is sufficiently small, the change in the imaging position is uniform within the imaging surface 11a and may be regarded as translation or rotational movement within the XY plane (image plane blur). Therefore, by translating or rotating the image sensor 11 within the XY plane so as to cancel the image plane blur, a clear object image with corrected blur can be obtained.

Similarly, the second image stabilizing unit 60 corrects an image blur caused by vibration occurring in the imaging system 10 by moving the image stabilizing lens 12b in the X and Y directions, thereby allowing a clear object image to be obtained. That is, by moving the image stabilizing lens 12b in the XY plane direction, a light beam from the object is refracted. At this time, the image stabilizing lens 12b is moved in the XY plane direction so as to cancel the image plane blur. Thereby, a clear object image with corrected blur can be obtained. Since the principle of the image stabilization by moving the image sensor 11 or the image stabilizing lens 12b is well known, a detailed description thereof will be omitted. The image stabilizing lens 12b may also be configured to move in the Z direction when moving in the XY plane direction.

The first image stabilizing unit 40 includes, for example, a fixed portion, a movable portion, and a plurality of driving force generators. The fixed portion is fixed to the base member 13c, and the movable portion holds the image sensor 11. The movable portion is supported on the fixed portion with three degrees of freedom, and is movable relative to the fixed portion in the X and Y directions or rotatable within the XY plane. That is, the first image stabilizing unit 40 is configured as a driving apparatus capable of drive control in three axes (so-called XYθ stage), and is capable of moving the image sensor 11 in the X and Y directions and rotating the image sensor 11 within the XY plane.

The second image stabilizing unit 60 includes, for example, a fixed portion, a movable portion, and a plurality of driving force generators. The fixed portion is fixed to a housing (not illustrated) of the lens apparatus 10b, and the movable portion holds the image stabilizing lens 12b. The movable portion is supported on the fixed portion with two degrees of freedom, and is movable relative to the fixed portion in the X and Y directions. That is, the second image stabilizing unit 60 is configured as a driving apparatus capable of drive control in two axes (so-called XY stage), and is capable of moving the image stabilizing lens 12b in the X and Y directions.

Each of the first vibration detector 16a and the second vibration detector 16b includes a gyro sensor, an acceleration sensor, or the like, and serves as a vibration detector configured to detect an angular velocity, acceleration, and the like in each direction of the imaging system 10 as vibration information on the imaging system 10.

Each of the first image stabilization control unit 15a and the second image stabilization control unit 15b calculates, as vibration information, an angular displacement amount and a moving amount in each direction of the imaging system 10 by integrating the angular velocity and acceleration detected by the first vibration detector 16a and the second vibration detector 16b.

The first image stabilization control unit 15a calculates a target movement value of the image sensor 11 based on the vibration information detected by the first vibration detector 16a, and controls the driving of the first image stabilizing unit 40 to control movement of the image sensor 11. Similarly, the second image stabilization control unit 15b calculates a target movement value of the image stabilizing lens 12b based on the vibration information detected by the second vibration detector 16b, and controls driving of the second image stabilizing unit 60 to control movement of the image stabilizing lens 12b. The imaging system 10 may have no second image stabilizing unit 60.

In a case where the second image stabilizing unit 60 is not provided, the image stabilizing lens 12b is basically unnecessary. In such a case, the imaging optical system 12 of the lens apparatus 10b is designed with a lens configuration that does not include the image stabilizing lens 12b so as to obtain desired optical characteristics.

Next, a detailed configuration of the first image stabilizing unit 40 will be described with reference to FIGS. 2A and 2B. Since the configuration of the second image stabilizing unit 60 is well known, a description thereof will be omitted. FIG. 2A is an exploded perspective view of the first image stabilizing unit 40 included in the imaging system 10 according to the present embodiment. FIG. 2B is an exploded perspective view of the first image stabilizing unit 40 when viewed from a direction different from that of FIG. 2A.

The first image stabilizing unit 40 includes a fixed portion 20, a movable portion 30, and balls 41a to 41c. The fixed portion 20 includes a front fixed portion 20a and a rear fixed portion 20b. In the first image stabilizing unit 40, the front fixed portion 20a, the movable portion 30, and the rear fixed portion 20b are arranged in this order from a side closer to the body-side mount member 13a in the Z direction.

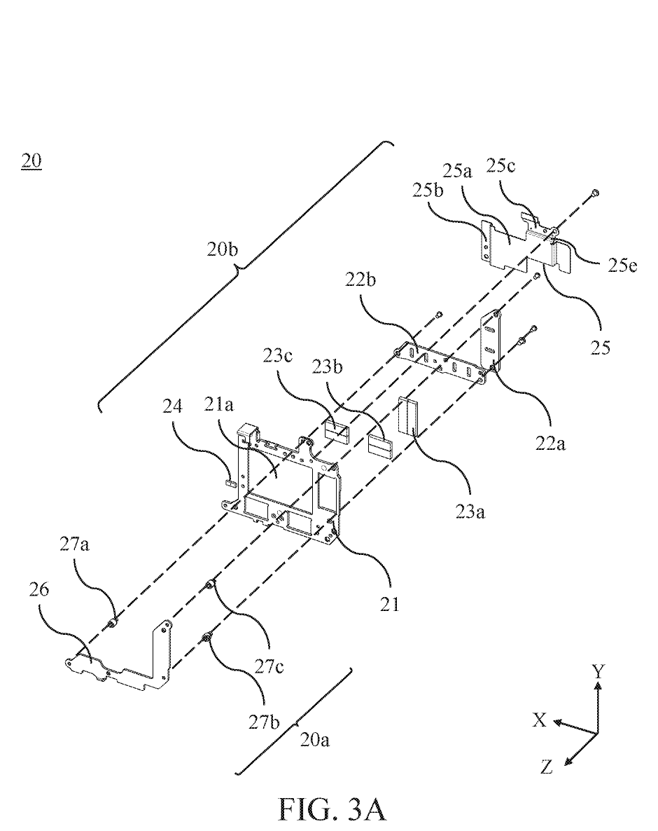

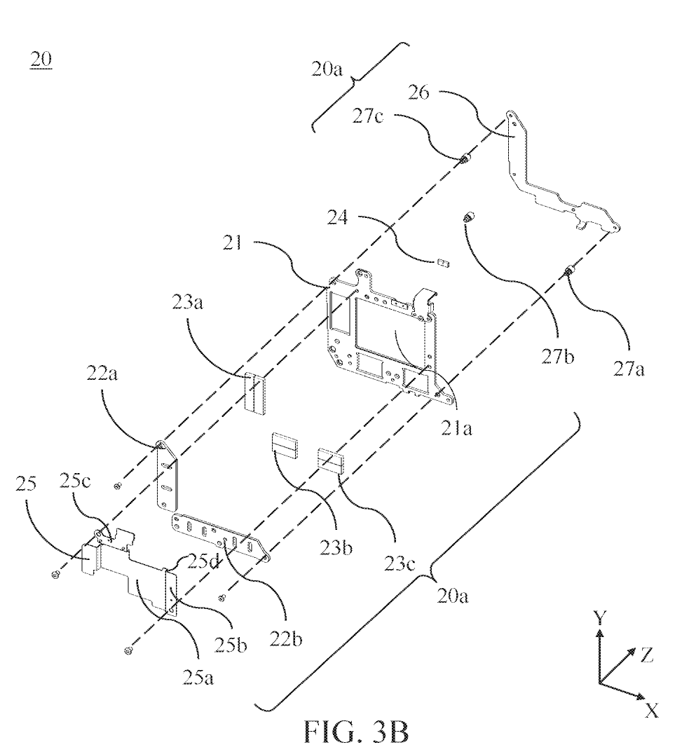

Next, the fixed portion 20 of the first image stabilizing unit 40 will be described with reference to FIGS. 3A and 3B. FIG. 3A is an exploded perspective view of the fixed portion 20. FIG. 3B is an exploded perspective view of the fixed portion 20 when viewed from a direction different from that of FIG. 3A.

The rear fixed portion 20b includes a base plate (fixed frame, first holding member) 21, a first rear yoke 22a, a second rear yoke 22b, a first magnet group 23a, a second magnet group 23b, a third magnet group 23c, a thrust magnet 24, and a fixed-portion heat dissipating plate 25. The base plate 21 functions as a fixed member disposed inside the body unit 10a of the imaging system 10. The base plate 21 has an opening (first opening) 21a and is formed of a non-magnetic material.

Each of the first magnet group 23a, the second magnet group 23b, and the third magnet group 23c is fixed to the first rear yoke 22a or the second rear yoke 22b by an adhesive or the like. Each of the first rear yoke 22a and the second rear yoke 22b is formed of a magnetic material. The first rear yoke 22a and the second rear yoke 22b are fixed to the base plate 21 with screws or the like. That is, the first magnet group 23a, the second magnet group 23b, and the third magnet group 23c are held by the base plate 21.

The thrust magnet 24 is fixed to the base plate 21 by an adhesive or the like.

The fixed-portion heat dissipating plate (first heat dissipating member) 25 has a planar portion (first surface) 25a parallel to the XY plane, and the planar portion 25a is disposed within the opening 21a of the base plate 21. The fixed-portion heat dissipating plate 25 is fixed to the base plate 21 with screws or the like while fixing surfaces (first contact surfaces) 25b and 25c contact the base plate 21. The fixed-portion heat dissipating plate 25 includes bent portions 25d and 25e that are perpendicular to the planar portion 25a and are respectively provided between the planar portion 25a and the fixing surfaces 25b and 25c. Each of the bent portions 25d and 25e may be bent at an angle greater than 0 degrees and equal to or less than 90 degrees relative to the planar portion 25a (that is, an angle formed between each bent portion and the planar portion 25a, based on an intersection between them, may be 90 degrees or more and less than 180 degrees). The planar portion 25a is configured to be closer to a planar portion (second surface) 36a of a movable-portion heat dissipating plate (second heat dissipating member) 36 described later than the fixing surfaces 25b and 25c. The planar portion 25a is disposed on a -Z direction side of an opening (second opening) 31a in a movable member (second holding member) 31 described later so as not to intrude into the opening 31a in the optical axis direction.

At least a surface of the planar portion 25a facing the planar portion 36a is subjected to a surface treatment for increasing the thermal emissivity. The thermal emissivity is a ratio of the energy of light (radiant intensity) emitted by an object due to the thermal radiation to the energy of light emitted by a black body at the same temperature, where the latter is defined as 1.

The front fixed portion 20a includes a front yoke 26, a first column member 27a, a second column member 27b, and a third column member 27c. The front yoke 26 is fixed to the base plate 21 of the rear fixed portion 20b via the first column member 27a, the second column member 27b, and the third column member 27c. The first column member 27a, the second column member 27b, and the third column member 27c are disposed at positions that restrict movement of the movable portion 30, and restrict movement of the movable portion 30 in the XY plane to a predetermined range. Buffer members such as rubber are provided at contact portions between the first to third column members 27a to 27c and the movable portion 30 to absorb impact upon contact, thereby preventing damage and reducing impact noise.

In the present embodiment, the first magnet group 23a, the second magnet group 23b, and the third magnet group 23c include two magnets magnetized in the Z direction and arranged so as to generate magnetic fields in opposite directions. However, the present embodiment is not limited to this example, and may use a single magnet magnetized with two poles.

The first rear yoke 22a and the front yoke 26 are arranged so as to sandwich the first magnet group 23a in the Z direction. The first magnet group 23a forms a first magnetic circuit passing through the first rear yoke 22a and the front yoke 26. The second rear yoke 22b and the front yoke 26 are arranged so as to sandwich the second magnet group 23b and the third magnet group 23c in the Z direction. Similarly to the first magnet group 23a, the second magnet group 23b and the third magnet group 23c form a second magnetic circuit and a third magnetic circuit, respectively.

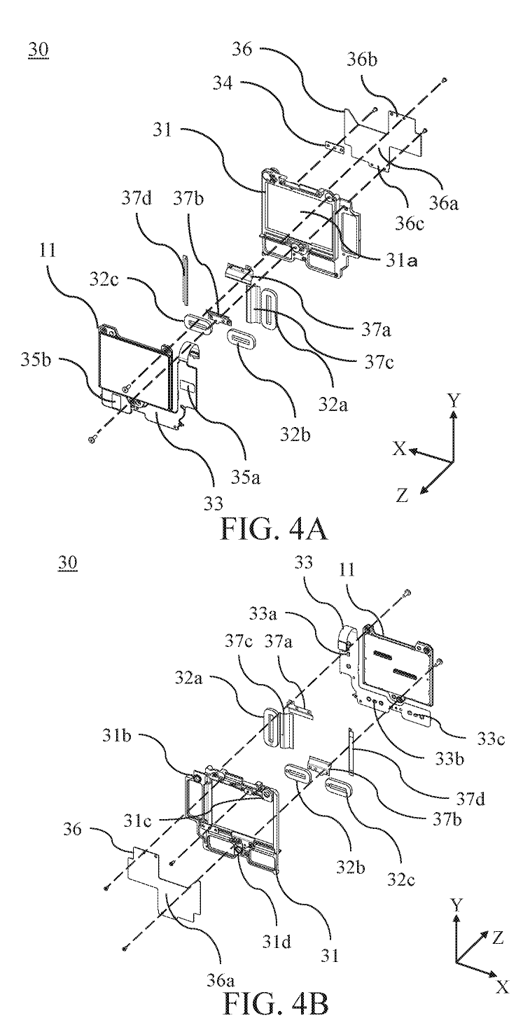

Next, the movable portion 30 of the first image stabilizing unit 40 will be described with reference to FIGS. 4A and 4B. FIG. 4A is an exploded perspective view of the movable portion 30. FIG. 4B is an exploded perspective view of the movable portion 30 when viewed from a direction different from that of FIG. 4A.

The movable portion 30 includes the image sensor 11, a movable member (movable frame, second holding member) 31, a first coil 32a, a second coil 32b, a third coil 32c, a driving FPC 33, a thrust yoke 34, and a movable-portion heat dissipating plate 36. The movable portion 30 further includes a first heat dissipation sheet 37a, a second heat dissipation sheet 37b, a third heat dissipation sheet 37c, and a fourth heat dissipation sheet 37d.

The image sensor 11 has a substantially rectangular shape and is fixed to the movable member 31 with screws or the like.

The movable member 31 holds the image sensor 11 and is movable in the XY plane relative to the base plate 21 serving as a fixed member. The movable member 31 has an opening 31a for attaching the imaging FPC 18 to the image sensor 11. The first coil 32a, the second coil 32b, and the third coil 32c are held by the movable member 31 and are disposed at positions facing the first magnet group 23a, the second magnet group 23b, and the third magnet group 23c, respectively.

The driving FPC 33 is disposed so as to overlap the first coil 32a, the second coil 32b, and the third coil 32c in an XY projected plane, and is fixed to the movable member 31 by an adhesive or the like.

The first magnetic circuit and the first coil 32a form a voice coil motor (VCM) serving as a first actuator. Similarly, the second magnetic circuit and the second coil 32b form a VCM serving as a second actuator, and the third magnetic circuit and the third coil 32c form a VCM serving as a third actuator.

A Lorentz force is generated in a direction orthogonal to a magnetic field generated in the Z direction by the first magnetic circuit and the current flowing through the first coil 32a, and a resultant direction of the Lorentz force changes depending on a direction of energization of the first coil 32a. Similar Lorentz forces are generated in the second magnetic circuit and the second coil 32b, and in the third magnetic circuit and the third coil 32c.

The first actuator generates a translational force in the X direction. The second actuator and the third actuator generate forces approximately parallel to the Y direction, and a sum of these forces generates a translational force in the Y direction, while a difference between these forces generates a rotational force about the optical axis. A first detection element 33a, a second detection element 33b, and a third detection element 33c are mounted on the driving FPC 33.

The first detection element 33a is disposed inside the first coil 32a, the second detection element 33b is disposed inside the second coil 32b, and the third detection element 33c is disposed inside the third coil 32c.

The first to third detection elements 33a to 33c include, for example, Hall elements. The first detection element 33a detects the magnetic force of the first magnetic circuit, and based on a detection result thereof, the first image stabilization control unit 15a calculates position information on the movable portion 30 relative to the fixed portion 20 in the XY plane, more specifically, position and an angle about the optical axis. This is similarly applied to the second detection element 33b and the third detection element 33c.

The first coil 32a, the second coil 32b, and the third coil 32c are electrically connected to the driving FPC 33. The first image stabilization control unit 15a controls the current supplied to each coil via the driving FPC 33. That is, the first image stabilization control unit 15a calculates a deviation between a target movement value of the image sensor 11 based on the vibration information detected by the first vibration detector 16a and the current position of the image sensor 11 detected by the first detection element 33a, the second detection element 33b, and the third detection element 33c. Then, the first image stabilization control unit 15a controls driving of the movable portion 30 by feedback control based on the deviation.

The movable portion 30 is supported on the base plate 21 via the balls 41a to 41c, which are rolling members, movably within the XY plane. The balls 41a to 41c are disposed inside a first enclosure portion 31b, a second enclosure portion 31c, and a third enclosure portion 31d provided in the movable member 31, respectively. That is, the plurality of balls 41a to 41c serving as rolling members are disposed so as to contact the movable member 31 and the base plate 21 serving as a fixed member. When the movable portion 30 moves relative to the fixed portion 20 within the XY plane, the balls 41a to 41c roll, so that a load due to friction with the movable member 31 and the base plate 21 is small.

The thrust yoke 34 is disposed at a position facing the thrust magnet 24 and is fixed to the movable member 31. The thrust magnet 24 forms a fourth magnetic circuit passing through the thrust yoke 34. The movable member 31 is biased toward the base plate 21 in the -Z direction by an attractive force generated between the thrust magnet 24 and the thrust yoke 34. That is, the thrust magnet 24 and the thrust yoke 34 constitute a first biasing portion that biases the movable portion 30 toward the fixed portion 20 in the -Z direction.

The movable portion 30 further includes a first thrust metal plate 35a and a second thrust metal plate 35b. The first thrust metal plate 35a is disposed at a position facing the first magnet group 23a, and the second thrust metal plate 35b is disposed at a position facing the third magnet group 23c, and each is fixed to the driving FPC 33 by an adhesive or the like.

The first thrust metal plate 35a and the second thrust metal plate 35b are formed of a magnetic material. That is, the first thrust metal plate 35a and the second thrust metal plate 35b function as yoke members held by the movable member 31 and disposed at positions facing the first magnet group 23a and the third magnet group 23c, respectively.

The first thrust metal plate 35a and the second thrust metal plate 35b generate attractive forces with the first magnet group 23a and the third magnet group 23c that they face, respectively. The first thrust metal plate 35a and the second thrust metal plate 35b respectively constitute a second biasing portion and a third biasing portion for biasing the movable member 31 toward the base plate 21 serving as a fixed member in the -Z direction. That is, the first thrust metal plate 35a and the second thrust metal plate 35b, serving as yoke members, bias the movable portion 30 toward the fixed portion 20 in the -Z direction.

The first biasing portion, the second biasing portion, and the third biasing portion are disposed in the XY plane such that a center of gravity of the movable portion 30 is positioned inside a triangle formed by connecting the biasing portions. This is similarly applied to the arrangement of the balls 41a to 41c. As a result, the biasing forces can be generated in a well-balanced manner on the movable portion 30. Accordingly, lifting of the movable portion 30 during driving can be suppressed.

A movable-portion heat dissipating plate (second heat dissipating member) 36 has a planar portion 36a parallel to the XY plane, and the planar portion 36a is disposed at a position facing the planar portion 25a of the fixed-portion heat dissipating plate 25. The movable-portion heat dissipating plate 36 is fixed to the movable member 31 with screws or the like while fixing surfaces (second contact surfaces) 36b and 36c contact the movable member 31. The planar portion 36a and the fixing surfaces 36b and 36c are disposed approximately on the same plane.

At least a surface of the planar portion 36a facing the planar portion 25a of the fixed-portion heat dissipating plate 25 is subjected to a surface treatment for increasing the thermal emissivity. The movable-portion heat dissipating plate 36 is disposed at a position partially overlapping the image sensor 11 in an XY projected plane. That is, the image sensor 11, the movable-portion heat dissipating plate 36, and the fixed-portion heat dissipating plate 25 are disposed such that at least parts of them overlap each other in the XY projected plane (that is, the image sensor 11, the movable-portion heat dissipating plate 36, and the fixed-portion heat dissipating plate 25 have an overlapping region when viewed in the optical axis direction).

Here, the planar portion 36a of the movable-portion heat dissipating plate 36 and the planar portion 25a of the fixed-portion heat dissipating plate 25 are disposed at positions that do not overlap the first actuator, the second actuator, or the third actuator in the XY projected area and that overlaps in the Z direction.

Each of the first heat dissipation sheet 37a, the second heat dissipation sheet 37b, the third heat dissipation sheet 37c, and the fourth heat dissipation sheet 37d is a thermally conductive member having one end attached to a corresponding one of four sides of the image sensor 11, which has a substantially rectangular shape. Each of the first heat dissipation sheet 37a, the second heat dissipation sheet 37b, the third heat dissipation sheet 37c, and the fourth heat dissipation sheet 37d has the other end connected to the movable member 31 and the movable-portion heat dissipating plate 36. That is, the movable-portion heat dissipating plate 36 is connected to the image sensor 11 via the heat dissipation sheets. The first heat dissipation sheet 37a, the second heat dissipation sheet 37b, the third heat dissipation sheet 37c, and the fourth heat dissipation sheet 37d include, for example, graphite sheets.

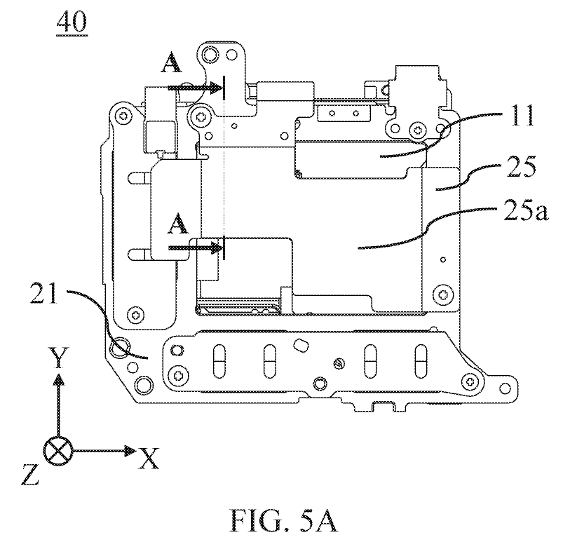

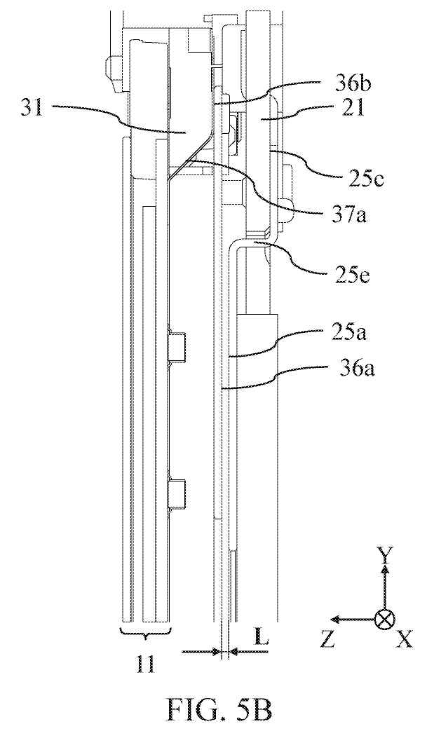

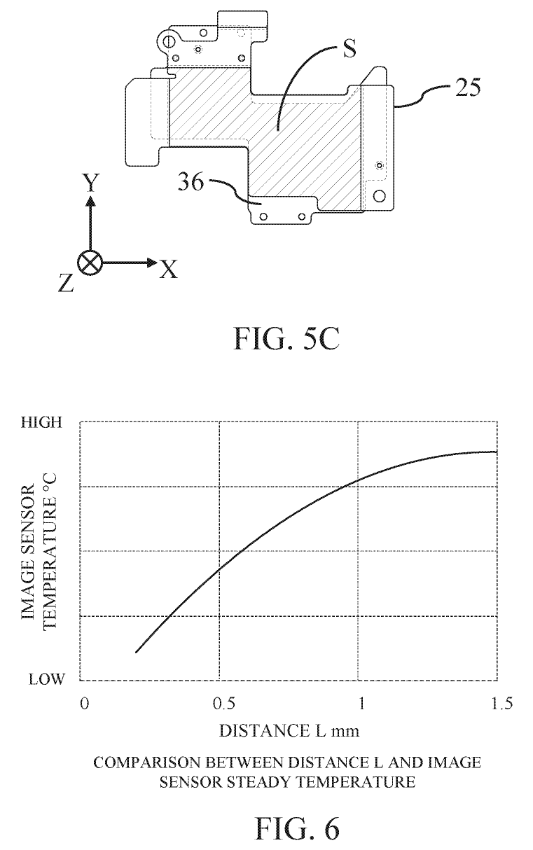

Next, a heat dissipation path of the image sensor 11 in the first image stabilizing unit 40 will be described with reference to FIGS. 5A, 5B and 5C. FIG. 5A is a rear view of the first image stabilizing unit 40. FIG. 5B is a sectional view of the first image stabilizing unit 40 taken along line A-A in FIG. 5A. FIG. 5C is a projected view illustrating a relationship between the fixed-portion heat dissipating plate 25 and the movable-portion heat dissipating plate 36, and illustrates only the fixed-portion heat dissipating plate 25 and the movable-portion heat dissipating plate 36 in FIG. 5A.

Heat generated when the image sensor 11 is driven is transmitted to the first heat dissipation sheet 37a connected to the image sensor 11. The first heat dissipation sheet 37a transmits the heat to the movable-portion heat dissipating plate 36. This is similarly applied to the second heat dissipation sheet 37b, the third heat dissipation sheet 37c, and the fourth heat dissipation sheet 37d.

Here, since the first to fourth heat dissipation sheets 37a to 37d are connected to the four sides of the substantially rectangular image sensor 11, the temperature variation within the image sensor 11 can be suppressed. The movable-portion heat dissipating plate 36 is disposed at a position overlapping the image sensor 11 in the XY projected area. Thus, a distance from the image sensor 11 to the movable-portion heat dissipating plate 36 through the first to fourth heat dissipation sheets 37a to 37d can be reduced, and the heat of the image sensor 11 can be efficiently transmitted to the movable-portion heat dissipating plate 36.

The heat dissipation sheet connecting the image sensor 11 and the movable-portion heat dissipating plate 36 is not limited to the configuration connected only to the four sides of the image sensor 11, and may be disposed approximately at a central portion. Alternatively, the heat dissipation sheet may be connected to at least two opposing sides among the four sides of the image sensor 11.

The heat of the image sensor 11 transmitted to the movable-portion heat dissipating plate 36 is transferred from the planar portion 36a of the movable-portion heat dissipating plate 36 to the planar portion 25a of the opposing fixed-portion heat dissipating plate 25 through air. Here, let L be a distance in the Z direction between the planar portion 25a and the planar portion 36a, and let S be an area in which the planar portion 25a and the planar portion 36a overlap each other in the XY projected plane (an area of an opposing region). In this case, an amount of heat conduction through air between the planar portion 25a and the planar portion 36a is, according to Fourier's law, inversely proportional to the distance L and proportional to the area S. Therefore, the heat dissipation performance can be increased by reducing the distance L. In the present embodiment, the distance L may be greater than 0 mm and equal to or less than 1 mm.

FIG. 6 illustrates an example of a temperature of the image sensor 11 during moving image capturing when the distance L is varied. In FIG. 6, a horizontal axis indicates the distance L (mm), and a vertical axis indicates the temperature (°C) of the image sensor 11. As illustrated in FIG. 6, when the distance L is equal to or less than 1 mm, the temperature of the image sensor 11 can be reduced more effectively.

As described above, the planar portion 36a of the movable-portion heat dissipating plate 36 and the planar portion 25a of the fixed-portion heat dissipating plate 25 are disposed at positions that do not overlap the first actuator, the second actuator, or the third actuator in the XY projected plane and that overlaps the first actuator, the second actuator, or the third actuator in the Z direction. Therefore, without increasing the size of the first image stabilizing unit 40, the area S can be increased to enhance the heat dissipation performance.

As described above, the heat dissipation performance is improved as the distance L between the planar portion 25a and the planar portion 36a decreases and as the opposing area S increases. On the other hand, since the movable-portion heat dissipating plate 36 is a movable portion, it is to be configured so as not to interfere with the fixed portion 20 during driving. If the planar portion 25a of the fixed-portion heat dissipating plate 25 intrudes into the opening 31a in the movable member 31, the planar portion 25a is forced to be reduced in size in order to avoid interference during driving, so that the area S in which the planar portion 25a and the planar portion 36a overlap each other in the XY projected plane decreases and the heat dissipation performance decreases. Therefore, in order to reduce the distance L while increasing the area S, the planar portion 25a is disposed at a position on the -Z direction side so as not to intrude into the opening 31a in the movable member 31 in the optical axis direction. That is, the planar portion 25a of the fixed-portion heat dissipating plate 25 does not overlap the opening 31a in the movable member 31 when viewed from a direction perpendicular to the optical axis 12a. Similarly, the planar portion 36a of the movable-portion heat dissipating plate 36 does not overlap the opening 21a of the base plate 21 when viewed from a direction perpendicular to the optical axis 12a.

In order to maintain the heat dissipation performance even when the movable-portion heat dissipating plate 36 moves in the XY plane by an image stabilizing mechanism, a change in the area S when the movable-portion heat dissipating plate 36 moves may be small within a movable range of the movable portion 30 (an entire movable range of the movable portion 30). A change rate of the area S (area of the opposing region) when the movable-portion heat dissipating plate 36 moves may be equal to or less than 10%. That is, within the entire movable range of the movable portion 30, the following inequality (1) may be satisfied:

(Smax - Smin)/Smax ≤ 0.1 (1)

where Smax is a maximum value of the area S and Smin is a minimum value of the area S.

In order to maximize the heat dissipation performance while the image sensor 11 is being driven, the area S may be maximum at the initial position of the movable portion 30, at which the center of the imaging surface 11a coincides with the optical axis 12a while the image stabilization is not performed. Further, the area S may change less within a range in which the movable portion 30 moves during continuous shooting or moving image capturing of the imaging system 10 than in a case where the movable portion 30 is at an end of the movable range.

As described above, the fixed-portion heat dissipating plate 25 and the movable-portion heat dissipating plate 36 are subjected to a surface treatment for increasing thermal emissivity. As described later, in the present embodiment, materials of the fixed-portion heat dissipating plate 25 and the movable-portion heat dissipating plate 36 include, for example, aluminum. While aluminum has high thermal conductivity, its thermal emissivity is less than 0.50. Therefore, by performing an anodizing treatment as the surface treatment on the planar portion 25a of the fixed-portion heat dissipating plate 25 and the planar portion 36a of the movable-portion heat dissipating plate 36, the thermal emissivity is increased to, for example, 0.50 or more. The surface treatment is not limited to anodizing, and may be painting, plating, blasting, or the like. Since a higher heat dissipation effect is expected as thermal emissivity increases, a proper treatment may be selected and performed according to the material to be surface-treated. By performing the surface treatment, radiant heat released from the movable-portion heat dissipating plate 36 into the air increases, and heat transfer to the fixed-portion heat dissipating plate 25 improves, thereby improving the heat dissipation performance of the movable portion 30.

Due to the above configuration, heat of the image sensor 11 can be transferred from the movable-portion heat dissipating plate 36 to the fixed-portion heat dissipating plate 25 by the heat conduction through air and radiant heat, thereby improving the heat dissipation performance from the image sensor 11. The first to fourth heat dissipation sheets 37a to 37d are also connected to the movable member 31. Therefore, the heat dissipation performance can be further improved by transmitting heat of the image sensor 11 not only to the movable-portion heat dissipating plate 36 but also to the movable member 31.

In the first image stabilizing unit 40, a direction in which the movable member 31 faces the base plate 21 and a direction in which the planar portion 36a of the movable-portion heat dissipating plate 36 faces the planar portion 25a of the fixed-portion heat dissipating plate 25 are both the -Z direction and are approximately the same. Therefore, when an impact larger than the biasing forces of the first to third biasing portions is applied from the outside in the +Z direction to the first image stabilizing unit 40 due to, for example, dropping of the imaging system 10, the movable portion 30 is temporarily displaced in the +Z direction to a position where the movable portion 30 contacts the front fixed portion 20a. That is, the planar portion 36a of the movable-portion heat dissipating plate 36 and the planar portion 25a of the fixed-portion heat dissipating plate 25 are displaced in a direction to separate from each other in the Z direction.

On the other hand, in a case where an impact larger than the biasing forces of the first to third biasing portions is applied from the outside in the -Z direction to the first image stabilizing unit 40, the movable portion 30 is in contact with the rear fixed portion 20b via the balls 41a to 41c, and thus the positions in the Z direction of the movable portion 30 and the rear fixed portion 20b do not change. That is, the distance between the planar portion 36a of the movable-portion heat dissipating plate 36 and the planar portion 25a of the fixed-portion heat dissipating plate 25 in the Z direction does not change. Therefore, even when the Z-direction distance L between the planar portion 36a of the movable-portion heat dissipating plate 36 and the planar portion 25a of the fixed-portion heat dissipating plate 25 is reduced to less than 1 mm for improving heat dissipation performance, deformation due to contact between the movable-portion heat dissipating plate 36 and the fixed-portion heat dissipating plate 25 upon application of an impact in the Z direction from the outside can be suppressed.

Next, the materials of components constituting the first image stabilizing unit 40 will be described. The base plate 21 may be made of a highly rigid material, such as stainless steel, so as to suppress deformation and changes in flange back in a case where a strong external impact such as dropping is applied to the imaging system 10.

The movable member 31 may be made of a low-density material, such as a magnesium alloy or a resin such as plastic, so as to reduce a weight of the movable portion 30 and improve the driving performance of the image stabilizing mechanism. As described above with reference to the heat dissipation path, since the heat of the image sensor 11 is also dissipated to the movable member 31 via the first to fourth heat dissipation sheets 37a to 37d, a magnesium alloy having high thermal conductivity may be used.

The movable-portion heat dissipating plate 36 may be made of a material having a thermal conductivity higher than that of the movable member 31, such as aluminum, in order to improve heat dissipation performance. The fixed-portion heat dissipating plate 25 may be made of a material having a thermal conductivity higher than that of the base plate 21, such as aluminum or copper, in order to improve heat dissipation performance. Due to these materials, heat dissipation performance of the image sensor 11 can be improved by the movable-portion heat dissipating plate 36 and the fixed-portion heat dissipating plate 25 having a high thermal conductivity. Forming the movable member 31 of a material having a lower density than the movable-portion heat dissipating plate 36 can reduce a weight of the movable portion 30 as a whole and suppress a reduction in driving performance of the image stabilizing mechanism.

Next, a change in flange back of the first image stabilizing unit 40 that occurs when the image sensor 11 generates heat will be described with reference to FIGS. 5A and 5B.

The heat generated when the image sensor 11 is driven is effectively dissipated to the fixed-portion heat dissipating plate 25 and the movable member 31 via the above-described heat dissipation path. Thus, each of the movable-portion heat dissipating plate 36 and the movable member 31 that fixes it, and the fixed-portion heat dissipating plate 25 and the base plate 21 that fixes it becomes at a high temperature. Here, as described above, when materials of respective components are selected in consideration of their functions, the fixed-portion heat dissipating plate 25 and the base plate 21 are selected to be different materials. That is, different materials having different coefficients of linear expansion are fixed to each other, and warpage occurs in the base plate 21 and the fixed-portion heat dissipating plate 25 due to a so-called bimetal effect. When the base plate 21 warps and is deformed, the position of the movable portion 30 held by the balls 41a to 41c in the Z direction changes, thereby changing flange back.

The present embodiment provides the bent portions 25d and 25e between the planar portion 25a of the fixed-portion heat dissipating plate 25 and the fixing surfaces 25b and 25c in order to suppress changes in flange back. By providing the bent portions 25d and 25e, which are relatively easily deformable, when the base plate 21 and the fixed-portion heat dissipating plate 25 warp due to the bimetal effect, the bent portions 25d and 25e actively bend or deform, thereby alleviating overall warpage. Thus, a change in flange back when the image sensor 11 generates the heat can be suppressed.

As described above, flange-back change due to the bimetal effect when the image sensor 11 generates heat and the bent portions of the heat dissipating plates for suppressing flange-back change have been described. In order to suppress changes in the flange back, a sufficient bending height of the bent portions may be secured. As described above, the planar portion 25a of the fixed-portion heat dissipating plate 25 may not intrude into the opening 31a in the optical axis direction. In order to achieve both, the fixing surfaces 25b and 25c of the fixed-portion heat dissipating plate 25 may be provided on a surface of the fixed-portion heat dissipating plate 25 on a side farther from the movable member 31 in a thickness direction (optical axis direction) of the base plate 21. Due to this configuration, the bent portions 25d and 25e can secure a bending height corresponding to the thickness of the base plate 21. Thus, the space in the optical axis direction can be effectively utilized, and the thickness of the second image stabilizing unit 60 in the optical axis direction can be configured to be relatively small.

In the present embodiment, the movable-portion heat dissipating plate 36 is configured as a flat plate having no bent portion, but may have a bent portion similar to that of the fixed-portion heat dissipating plate 25. In this case, the bent portion may be bent at an angle greater than 0 degrees and equal to or less than 90 degrees relative to the planar portion 36a. The movable member 31 is made of a magnesium alloy or a resin such as plastic, and the movable-portion heat dissipating plate 36 is made of aluminum. That is, different materials are fixed so as to be integrated with each other, and warpage occurs in the movable member 31 and the movable-portion heat dissipating plate 36 due to the bimetal effect. Thus, by providing a bent portion in the movable-portion heat dissipating plate 36, a change in flange back when the image sensor 11 generates heat can be further suppressed.

On the other hand, in order to improve the heat dissipation performance, the distance L between the planar portion 25a and the planar portion 36a may be reduced. However, in a shape having a bent portion between the planar portion 36a and the fixing surfaces 36b and 36c, the tolerances between the planar portion 36a and the fixing surfaces 36b and 36c increase. Since the fixed-portion heat dissipating plate 25 and the movable-portion heat dissipating plate 36 are respectively a fixed portion and a movable portion, they may not contact each other in consideration of variations in components. Therefore, the present embodiment eliminates the bent portion of the movable-portion heat dissipating plate 36 to reduce component tolerances, and prioritizes the heat dissipation performance by reducing the distance L as much as possible.

In the present embodiment, the planar portion 25a and the planar portion 36a have an opposing region in which they face each other in the optical axis direction. A distance between the planar portion 25a and the planar portion 36a in the optical axis direction may be greater than 0 mm and equal to or less than 1 mm. The fixed-portion heat dissipating plate 25 and the movable-portion heat dissipating plate 36 may be adjacent to each other in the optical axis direction. The opposing region of the planar portions 25a and 36a is disposed, in the optical axis direction, at the same position as one of the first contact surfaces (25b, 25c) and the second contact surfaces (36b, 36c), or between the first contact surfaces and the second contact surfaces.

This embodiment can provide an imaging unit and an image pickup apparatus, each of which can improve the heat dissipation performance from the image sensor while suppressing a reduction in driving performance of the image stabilizing mechanism.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-062688, filed on Apr. 4, 2025, which is hereby incorporated by reference herein in its entirety.

What is claimed is:

1. An imaging unit comprising:
an image sensor;
a fixed portion;
a movable portion that holds the image sensor and is supported movably relative to the fixed portion in a plane perpendicular to an optical axis; and
a magnet and a coil configured to drive the movable portion,
wherein the fixed portion includes a first holding member that holds the magnet or the coil, and a first heat dissipating member,
wherein the movable portion includes a second holding member that holds the image sensor, and a second heat dissipating member,
wherein the first heat dissipating member has a first surface perpendicular to the optical axis,
wherein the second heat dissipating member has a second surface perpendicular to the optical axis, and
wherein the first surface and the second surface have an opposing region in which the first surface and the second surface face each other in an optical axis direction.

2. The imaging unit according to claim 1, wherein a distance between the first surface and the second surface in the optical axis direction is greater than 0 mm and equal to or less than 1 mm.

3. The imaging unit according to claim 1, wherein the first heat dissipating member and the second heat dissipating member are adjacent to each other in the optical axis direction.

4. The imaging unit according to claim 1, wherein the first heat dissipating member is made of a material having a thermal conductivity higher than that of the first holding member.

5. The imaging unit according to claim 1, wherein the second heat dissipating member is made of a material having a thermal conductivity higher than that of the second holding member.

6. The imaging unit according to claim 1, wherein the movable portion includes a thermally conductive member, and
wherein the second heat dissipating member is connected to the image sensor via the thermally conductive member.

7. The imaging unit according to claim 6, wherein one end of the thermally conductive member is connected to a center of the image sensor or to at least two opposing sides of the image sensor.

8. The imaging unit according to claim 1, wherein the image sensor, the first heat dissipating member, and the second heat dissipating member have an overlapping region when viewed in the optical axis direction.

9. The imaging unit according to claim 1, wherein the second holding member is made of a material having a density lower than that of the second heat dissipating member.

10. The imaging unit according to claim 1, wherein a direction in which the second holding member faces the first holding member and a direction in which the second surface of the second heat dissipating member faces the first surface of the first heat dissipating member are the same.

11. The imaging unit according to claim 1, wherein the first surface and the second surface have the opposing region within an entire movable range of the movable portion.

12. The imaging unit according to claim 11, wherein the following inequality is satisfied:
(Smax - Smin)/Smax ≤ 0.1
where Smax is a maximum area of the opposing region, and Smin is a minimum area of the opposing region within the entire movable range.

13. The imaging unit according to claim 1, wherein each of the first surface and the second surface is subjected to a surface treatment for increasing a thermal emissivity.

14. The imaging unit according to claim 13, wherein the thermal emissivity of each of the first surface and the second surface is 0.50 or more.

15. The imaging unit according to claim 1, wherein the first holding member has a first opening,
wherein the second holding member has a second opening,
wherein the first surface does not overlap the second opening when viewed from a direction perpendicular to the optical axis, and
wherein the second surface does not overlap the first opening when viewed from the direction perpendicular to the optical axis.

16. The imaging unit according to claim 1, wherein the first heat dissipating member has a first contact surface that contacts the first holding member,
wherein the second heat dissipating member has a second contact surface that contacts the second holding member, and
wherein a bent portion is provided in at least one of a region between the first contact surface and the first surface and a region between the second contact surface and the second surface.

17. The imaging unit according to claim 16, wherein the bent portion is bent at an angle greater than 0 degrees and equal to or less than 90 degrees relative to the first surface or the second surface.

18. The imaging unit according to claim 16, wherein the opposing region is disposed, in the optical axis direction, at the same position as one of the first contact surface and the second contact surface, or between the first contact surface and the second contact surface.

19. The imaging unit according to claim 16, wherein the first contact surface is a surface of the first heat dissipating member that is farther from the second heat dissipating member in the optical axis direction.

20. An image pickup apparatus comprising:
the imaging unit according to claim 1; and
a control unit configured to control the imaging unit.
